(19) United States
(12) Patent Application Publication
(10) Pub. No.: US 2010/0306120 A1
(43) Pub. Date: Dec. 2, 2010

(54) ONLINE MERCHANDISING AND ECOMMERCE WITH VIRTUAL REALITY SIMULATION OF AN ACTUAL RETAIL LOCATION

(76) Inventor: Yunus Ciptawilangga, Bandung (ID)

Correspondence Address: Vern Maine & Associates, 547 AMHERST STREET, 3RD FLOOR, NASHUA, NH, 03063-4000, US

(21) Appl. No.: 12/474,202

(22) Filed: May 28, 2009

(51) Int. Cl. G06Q 10/00; G06Q 30/00

(52) U.S. Cl. 705/319; 705/27; 715/850; 705/1.1

(57) ABSTRACT

An online merchandising and promotion system is disclosed that closely simulates an interior space of an actual place of business in a virtual reality world. As consumers use avatars to explore the simulated space, they become simultaneously familiar with both the simulated and actual places of business, and thereafter can shop at both locations with equal ease. Previous familiarity with the actual place of business can motivate a consumer to visit the corresponding simulated location. In preferred embodiments, users can purchase virtual and/or real goods at the simulated place of business. Some simulated spaces enable avatars to socialize with each other, thereby prolonging their shopping and/or their exposure to advertising. In various embodiments, avatars can work to earn money, and/or avatars can earn virtual money by making real money purchases. Avatars can also gain status, and can compete with each other based on wealth, virtual possessions, and/or status.

### FIELD OF THE INVENTION

The invention generally relates to online advertising, merchandising, and ecommerce systems, and more specifically to advertising, merchandising, and e-commerce systems that are implemented in a virtual reality world.

### BACKGROUND OF THE INVENTION

Internet-accessible “virtual reality worlds” have become increasingly popular as personal computers have grown in power and become widely affordable, and as high-speed internet access has become commonplace. A virtual reality world can provide to an internet user an illusion of exploring, interacting with, and generally existing in a realistic, computer-generated world. Internet-accessible virtual reality worlds are typically hosted by one or more internet servers, and can be accessed over the internet using almost any internet-capable device, such as a personal computer or a portable, hand-held internet-capable device.

Typically, a user interacts with a virtual reality world by controlling the actions of a virtual person, or “avatar.” In many virtual reality worlds, avatars are able to represent the actions of real people in many ways, such as by looking in different directions, moving to different locations, entering buildings, handling objects, and even interacting with other avatars. Interactions between avatars can include speaking, showing facial expressions, and using movements to display a range of feelings and emotions, for example by drooping over to indicate illness, shedding tears to show sadness, or jumping around to show joy or excitement.

Electronic advertising and ecommerce are known to be included in some virtual reality worlds, whereby avatars are able to view and/or listen to advertisements, view and/or handle items for sale, and even complete purchase transactions for selected items, which are then shipped in the real world to the controller of the avatar. Some virtual reality worlds provide virtual retail locations, where an avatar controlled by a consumer can interact with an avatar controlled by a vendor, thereby representing an interaction between a customer and a retail salesperson. The two avatars can exchange information regarding products for sale, consider options, and complete an actual purchase transaction.

While advertising and ecommerce in a virtual reality world are powerful and enjoyable tools for increasing awareness of products and retail brands, and for facilitating online purchases, they do little to attract customers to visit actual places of business in the real world. In fact, in some cases, successful ecommerce can serve to compete with, and thereby decrease, the success of a real-world retail location, even if the real-world retail location operates under the same retail brand and offers the same products as the ecommerce in the virtual reality world.

### SUMMARY OF THE INVENTION

An electronic advertising and ecommerce system is claimed that increases total sales by closely simulating the interior space of an actual place of business in a virtual reality world. A sales-enhancing synergy is created between the actual place of business and its simulated counterpart, since a customer need only become familiar with one of the two so as to be immediately familiar and comfortable with the other. In fact, having visited the simulated location, a customer may be curious as to the accuracy of the simulation, and this curiosity may increase the customer's interest in visiting the corresponding real-world place of business. Similarly, if a customer has visited a real-world place of business, the customer may wish to visit its simulated counterpart so as to compare the two and experience the fidelity of the simulation.

The simulated place of business serves as an advertisement for the corresponding actual place of business, and typically also includes representations of traditional advertising features, such as product logos, product packaging, point-of-purchase displays, and signage, to which users are exposed as they direct their avatars to explore the simulated location. In preferred embodiments, users can purchase real products and/or services in the simulated place of business and have them delivered in the real world. In other preferred embodiments, users can purchase virtual products and/or services using virtual money, thereby enhancing the user's enjoyment of the virtual reality experience and enhancing the promotional value of the simulated place of business. In still other preferred embodiments, simulated places of business enable avatars to socialize with each other, thereby prolonging their shopping and/or exposure to advertising.

In certain embodiments, avatars can work within the virtual reality world so as to earn virtual money that can be used to purchase virtual and/or real consumables. In other preferred embodiments, avatars can earn virtual money by making real-money purchases of real-world goods.

In various embodiments, avatars can earn virtual status, and can compete with each other based on relative amounts of virtual wealth, virtual possessions, and/or virtual status. Achieving virtual status can also result in the awarding of special privileges, such as granting the avatar access to a status location in the virtual world, making a special status email address available to the user, and/or providing a special VIP membership card to the avatar and/or to the user.

If a real-world place of business is located near a consumer's residence and is familiar to the consumer, the consumer may choose on any given occasion to visit either the real-world place of business in person, or use the present invention to visit the corresponding simulation of the place of business without leaving the comfort of his or her place of residence. On the other hand, if the real-world palace of business is located far from the consumer's location, for example if the real-world place of business is famous, and is known to the consumer only by reputation, the present invention can provide to the consumer an opportunity to make a simulated visit to the famous place of business, and to enjoy a simulated shopping experience there, preferably making real purchases, without any need to travel to the actual location of the famous place of business.

The present invention is a system for electronic merchandising and promotion. The system includes media containing software that is operable on a computer and accessible to a user, the software being able to create and present to the user a virtual reality world. The virtual reality world includes a simulated place of business having a simulated interior space, the simulated interior space closely simulating a real interior space of a corresponding real-world place of business, and a virtual consumer that is controllable by the user so as to enable the user to experience a simulated visit to the real-world place of business. In preferred embodiments, the software is accessible to the user over at a network and/or the internet.

In some preferred embodiments, the simulated place of business includes an advertising feature that is a visible advertisement, an audible advertisement, a visible branding logo, and/or a virtual representation of a real-world product.

In certain preferred embodiments, the simulated place of business includes a virtual consumable, the virtual consumable corresponding to a real-world consumable that is available for purchase at the corresponding real-world place of business, the real-world consumable being a real product or a real service.

In various preferred embodiments, the virtual consumer is controllable by the user so as to purchase a consumable at the simulated place of business, the consumable being at least one of a virtual product, a real product, a virtual service, and a real service. And in some of these embodiments the simulated place of business includes a virtual sales enabler that is able interact with the virtual consumer so as to facilitate the purchase of the consumable at the simulated place of business. In some of these embodiments, the virtual sales enabler is controllable by the software and/or a real representative of the corresponding real place of business.

In preferred embodiments, the virtual reality world enables a competition between the user and a plurality of virtual competitors. In some of these embodiments at least one of the plurality of virtual competitors is controlled by a competing user. And in other of these embodiments, at least one of the plurality of virtual competitors is controlled automatically by the software.

In various preferred embodiments, the virtual consumer is able to obtain virtual social status in the virtual reality world. In some of these embodiments, the attainment of virtual social status can be accomplished by one or more of the following:

accumulating virtual money that is usable in the virtual reality world;

acquiring products through making purchases in the virtual reality world;

developing a talent in the virtual reality world; and

enhancing a personal image in the virtual reality world.

In other of these preferred embodiments, a reward can be earned by the virtual consumer due to attainment of a specified level of virtual social status. And in some of these embodiments the reward is at least one of the following:

allowing the virtual consumer to visit a status location within the virtual reality world;

providing a status email address for the user;

providing a status membership card to the user; and/or

awarding a prize to the user.

In preferred embodiments, the user is able to control the virtual consumer so as to earn virtual money for use in purchasing consumables in the virtual reality world. In some preferred embodiments the user is able to earn virtual money for use in purchasing consumables in the virtual reality world by using real money to purchase a consumable in the virtual reality world. And in other preferred embodiments the user is able to earn virtual money for use in purchasing consumables in the virtual reality world by purchasing a real consumable from a real place of business that corresponds to a simulated place of business in the virtual reality world.

In various preferred embodiments the virtual reality world includes at least one virtual city that corresponds to a real-world city. In certain preferred embodiments the virtual consumer is able to interact socially within the simulated interior space of the simulated place of business, the social interaction being with other virtual consumers controlled by other users. And in some preferred embodiments the user is able to adjust a virtual physical characteristic of the virtual consumer so as to approximate a corresponding physical characteristic of the user.

### BRIEF DESCRIPTION OF THE DRAWINGS

The invention will be more fully understood by reference to the detailed description, in conjunction with the following figures, wherein:

FIG. 1 is a perspective drawing that illustrates a user directing an avatar to order a cup of virtual coffee in a virtual coffee shop that is a simulation of a real coffee shop, while the avatar is exposed to brand logo advertising for the coffee shop;

FIG. 2 is a perspective drawing that illustrates the avatar of FIG. 1 interacting and socializing with other avatars in the virtual coffee shop of FIG. 1, while being exposed to the brand logo advertising;

FIG. 3 is a perspective drawing that illustrates the avatar of FIG. 1 browsing through a virtual bookstore that is an accurate simulation of a real-world bookstore, while being exposed to bookstore brand advertising and becoming simultaneously familiar with the inventory and layout of both the simulated and the real bookstore;

FIG. 4 is a perspective drawing that illustrates the avatar of FIG. 1 visiting a virtual toy store that is an accurate virtual simulation of a famous real-world toy store, the real-world toy store being located at a large distance from the user, but being nevertheless known to the user due to its international fame;

FIG. 5A is a perspective drawing that illustrates the avatar of FIG. 1 trying on virtual clothing in a virtual clothing store that is an accurate virtual simulation of a real-world clothing store;

FIG. 5B is a perspective drawing that illustrates a female avatar trying on jewelry in a jewelry store that is an accurate virtual simulation of a real-world jewelry store; and

FIG. 6 is a perspective drawing that illustrates the avatar of FIG. 1 exploring a virtual simulation of an apartment that corresponds to a real-world apartment that is for rent.

### DETAILED DESCRIPTION OF PREFERRED EMBODIMENTS

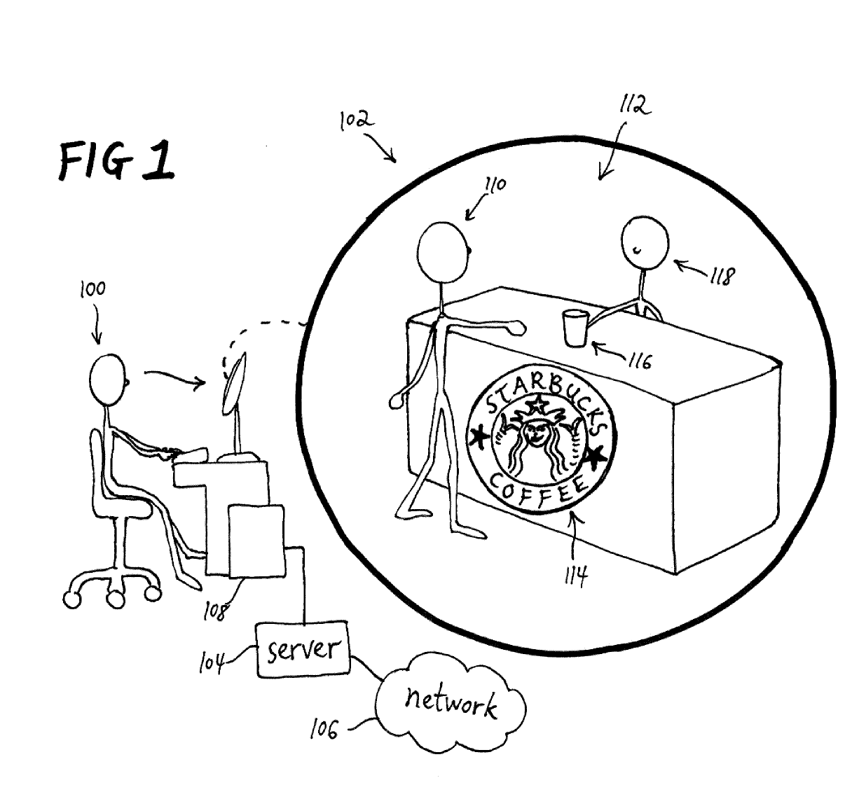

With reference to FIG. 1, the present invention is a system for online advertising and merchandising that allows a user 100 to access a virtual reality world 102, preferably by connecting to a server 104 over a network or the internet 106. In FIG. 1, the user 100 is shown accessing a network using a personal computer 108. The user is able to control the actions of a virtual consumer 110, or “avatar” 110 so as to explore a simulated interior space 112 of a simulated place of business 102, which in FIG. 1 is a coffee shop.

The simulated interior space 112 closely simulates a real interior space of a corresponding real-world place of business. Hence, in causing the avatar 110 to visit, explore, and interact with the simulated interior space 112, the user 100 automatically becomes familiar with both the simulated interior space 112 and the corresponding real-world place of business. If the user has already visited the real-world place of business in the past, the user is likely to be induced by curiosity to visit the corresponding simulated interior space 112 so as to observe the fidelity of the simulation. And if the user has not previously visited the real-world place of business, the user may be induced by curiosity, after visiting the simulated interior space 112, to visit the real-world place of business.

The simulated interior space 112 serves an advertising and/or marketing function, in that it increases the likelihood that a visitor will also visit the corresponding real-world place of business. Typically, the simulated interior space 112 also includes additional elements that performs advertising and/or marketing functions. For example, the coffee shop in FIG. 1 includes a branded logo 114 that promotes awareness of the corresponding real-world place of business. Also, the virtual representation of an actual consumable product, such as the cup of coffee 116 illustrated in FIG. 1, serves an advertising function in that it increases the awareness of the user that coffee can be obtained at the corresponding real-world place of business.

In the embodiment of FIG. 1, the avatar 110 is able to purchase the virtual cup of coffee 116 from a virtual sales enabler 118 that is automatically controlled by software. The virtual sales enabler 116, which in FIG. 1 is a virtual coffee sales clerk 116, is able to explain features of the consumable product(s) to the user through the user's avatar 110, and to provide other sales assistance as needed. In some embodiments, the user 100 is able to purchase real-world products through appropriate control of the avatar 110. For example, the user 100 may be able to purchase a coffee brewing apparatus in the simulated interior space 112 of FIG. 1, and have the corresponding real-world product shipped to the user's home in the real world. In other embodiments, the user is able to purchase virtual products that will enhance the simulated status of the avatar, or otherwise enhance the user's enjoyment of the virtual reality world.

In some embodiments, real-money purchases, transacted either within the simulated interior space 112 and/or at a real-world place of business that corresponds to a simulated interior space in the virtual reality world, enable an avatar 110 to accumulate virtual money, which can then be used to purchase additional virtual and/or real products. And in some embodiments, avatars can earn virtual money by performing services within the virtual world. For example, instead of a virtual sales enabler 116 that is automatically controlled by software, a second avatar controlled by a second user can sell products to consumer avatars in the simulated interior space 112.

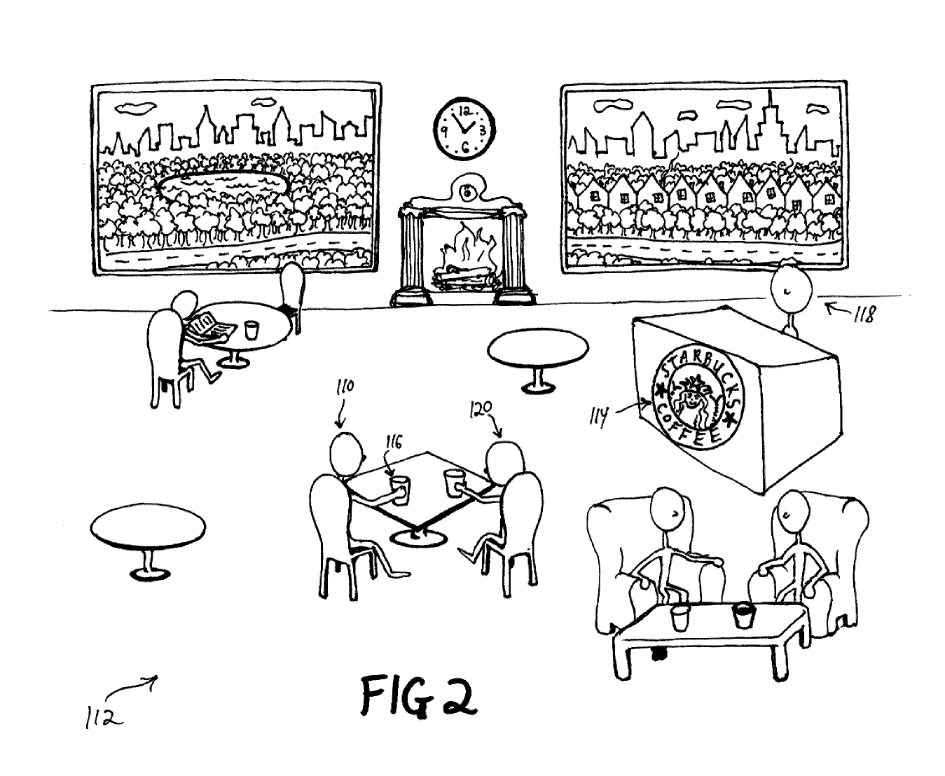

FIG. 2 illustrates an expanded view of the simulated interior space 112 of FIG. 1. In FIG. 2 it can be seen that the simulated interior space 112 provides an opportunity for the avatar 110 to socialize with a second avatar 120 controlled by a second user. This ability to socialize enhances the enjoyment of the simulated interior space 112, and thereby induces the avatar 110, and hence the user 100, to spend more time in the simulated interior space 112, thereby extending the exposure of the avatar 110 and of the user 100 to the advertising features 114, 116 located within the simulated interior space 112, and increasing the likelihood that additional purchases will be made.

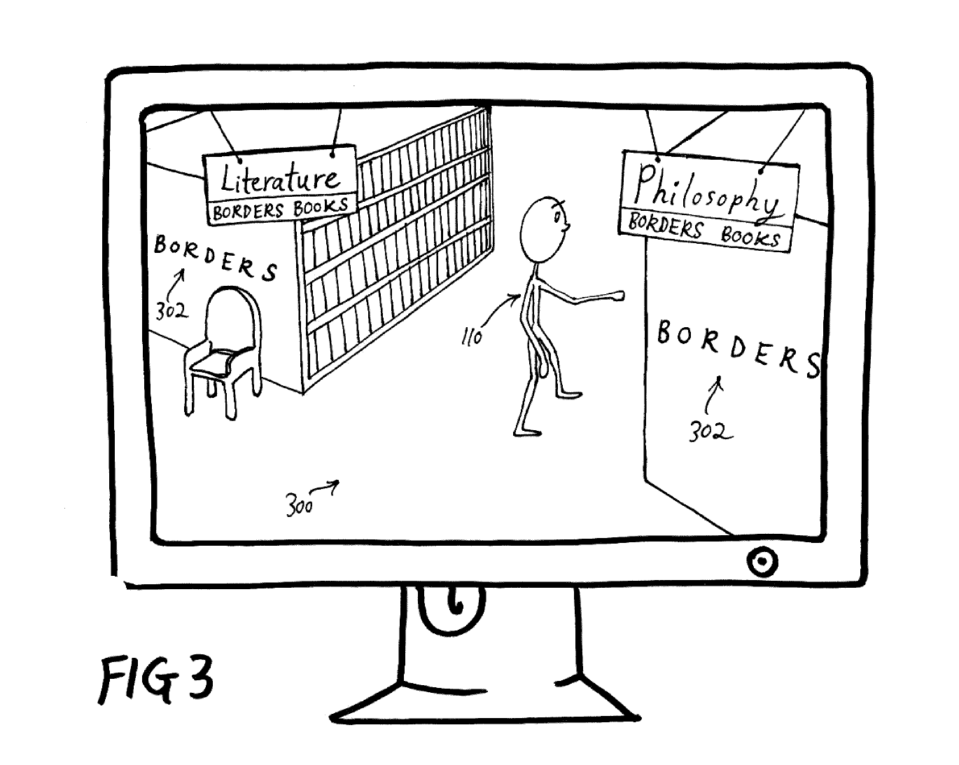

FIG. 3 shows the avatar 110 of FIG. 1 exploring the interior of a bookstore 300, while being exposed to bookstore branding logos 302, and while becoming familiar with the inventory and layout of the simulated interior 300, and thereby with the corresponding real-world place of business.

In this embodiment, the avatar 110 can purchase virtual books and/or real-world books. If the avatar purchases real-world books, they are shipped to the user 100. If the avatar purchases virtual books with certain properties, such as virtual literary classics, virtual educational books, and/or virtual books concerning popular music, the avatar 110 can thereby demonstrate its virtual “taste” and improve its virtual “education,” thereby increasing its virtual status in the virtual reality world. In preferred embodiments, avatars can compete with each other on the basis of virtual status, and in some embodiments the attainment of specific types and/or amounts of virtual status can cause an avatar 110 to earn rewards, such as access to a certain “status” location within the virtual world, and/or premiums for the user 100, such as a special email address, membership card, and such like.

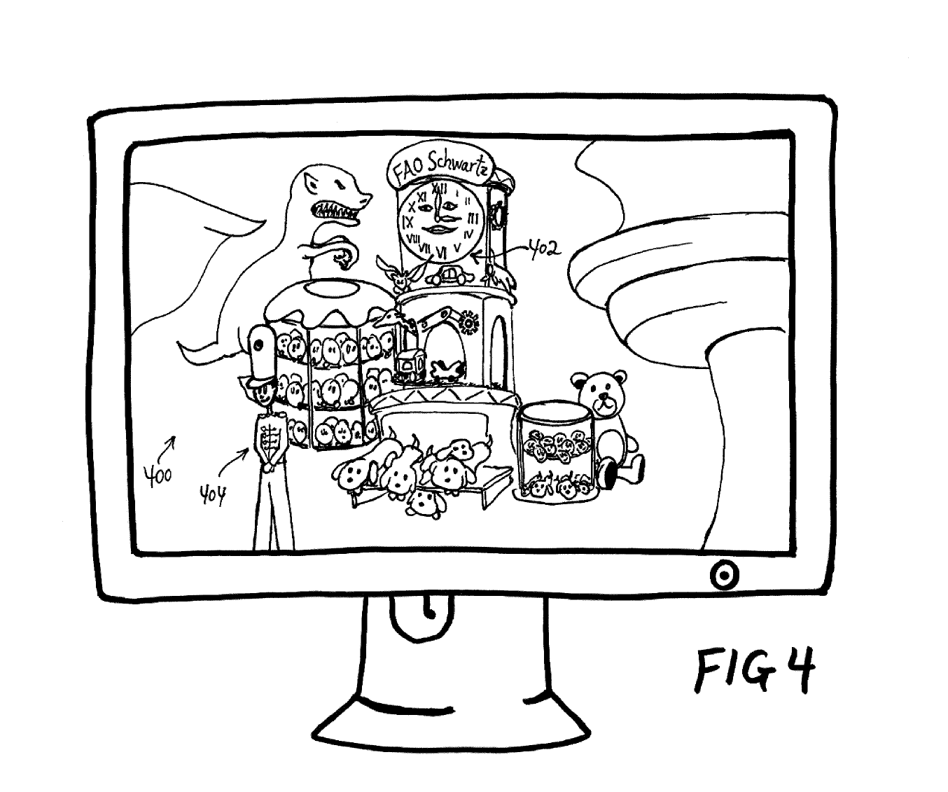

FIG. 4 illustrates an embodiment wherein the simulated interior space 400 closely simulates a famous real-world place of business, which would typically be known by reputation to users who are not located near the place of business in the real world. Such users might be induced by curiosity about the famous place of business to explore the corresponding simulated interior space 400, and to make online purchases during their simulated visits. The simulated interior space of FIG. 4 includes a clock 402 that shows the actual time at the real-world place of business, and also includes a virtual sales enabler 404 acting as a sales clerk. In similar embodiments, realistic simulations are provided of famous places of interest, such as castles and museums, where users can enjoy realistic simulated tours ending in virtual gift shops that correspond to real-world gift shops located at the real-world famous places of interest.

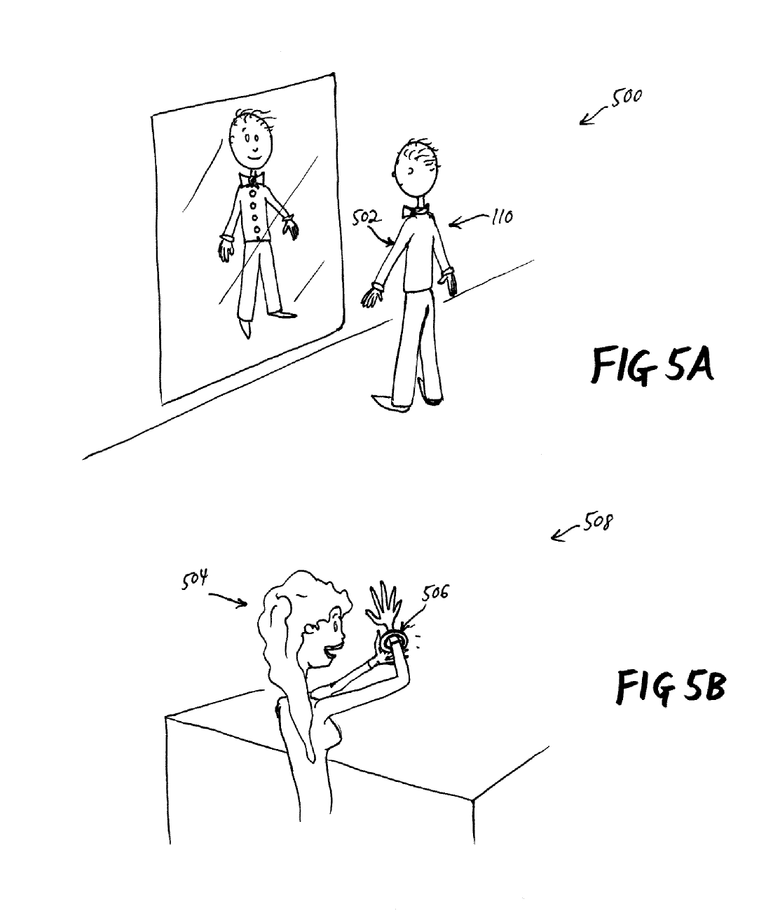

FIG. 5A illustrates an avatar 110 trying on an item of clothing 502 in a simulated interior space 500 that corresponds to a real-world clothing store. In some embodiments, the appearance of the avatar can be adjusted by the user 100 so as to approximate the user's weight, shape, and/or hair coloring, so that the appearance of virtual clothing worn by the avatar will provide a realistic simulation of the appearance of the corresponding real-world clothing when worn by the user 100. FIG. 5B illustrates a female avatar 504 trying on an item of jewelry 506 in a simulated interior space 508 that corresponds to a real-world jewelry store.

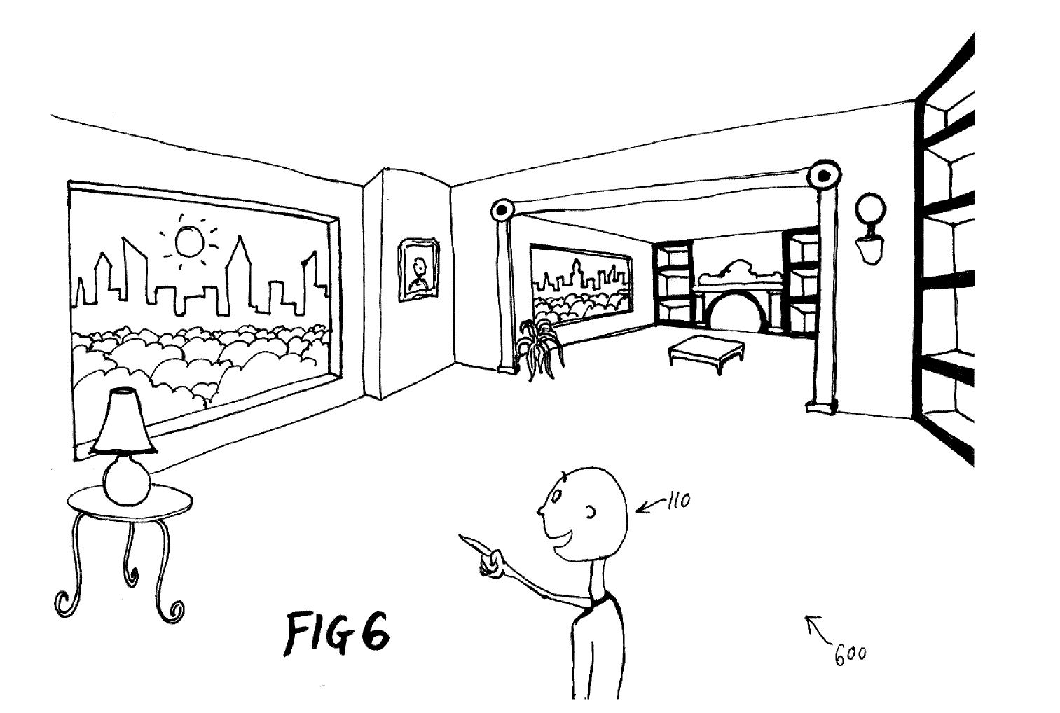

In some embodiments, it the simulated interior space itself that is the consumable item. For example, FIG. 6 shows the avatar of FIG. 1 exploring a simulated interior space 600 that is a close simulation of the interior of a real-world apartment that is for rent. After exploring and becoming familiar with several such simulated apartments, the user can choose a small number of candidates to visit, and select therefrom an apartment to rent. Or if the user is visit in person, the embodiment of FIG. 6 can allow the user to review available apartments and complete an online transaction to rent the one that seems most suitable, without ever having seen the apartment in person.

Other modifications and implementations will occur to those skilled in the art without departing from the spirit and the scope of the invention as claimed. Accordingly, the above description is not intended to limit the invention except as indicated in the following claims.

What is claimed is:

1. A system for electronic merchandising and promotion, comprising:
media containing software that is operable on a computer and accessible to a user, the software being able to create and present to the user a virtual reality world, the virtual reality world including:
a simulated place of business having a simulated interior space, the simulated interior space closely simulating a real interior space of a corresponding real-world place of business; and
a virtual consumer that is controllable by the user so as to enable the user to experience a simulated visit to the real-world place of business.

2. The system of claim 1, wherein the software is accessible to the user over at least one of:
a network; and
the internet.

3. The system of claim 1, wherein the simulated place of business includes an advertising feature that is at least one of:
a visible advertisement;
an audible advertisement;
a visible branding logo; and
a virtual representation of a real-world product.

4. The system of claim 1, wherein the simulated place of business includes a virtual consumable, the virtual consumable corresponding to a real-world consumable that is available for purchase at the corresponding real-world place of business, the real-world consumable being one of a real product and a real service.

5. The system of claim 1, wherein the virtual consumer is controllable by the user so as to purchase a consumable at the simulated place of business, the consumable being at least one of a virtual product, a real product, a virtual service, and a real service.

6. The system of claim 5, wherein the simulated place of business includes a virtual sales enabler that is able interact with the virtual consumer so as to facilitate the purchase of the consumable at the simulated place of business.

7. The system of claim 6, wherein the virtual sales enabler is controllable by at least one of:
the software; and
a real representative of the corresponding real place of business.

8. The system of claim 1, wherein the virtual reality world enables a competition between the user and a plurality of virtual competitors.

9. The system of claim 8, wherein at least one of the plurality of virtual competitors is controlled by a competing user.

10. The system of claim 8, wherein at least one of the plurality of virtual competitors is controlled automatically by the software.

11. The system of claim 1, wherein the virtual consumer is able to obtain virtual social status in the virtual reality world.

12. The system of claim 11, wherein the attainment of virtual social status can be accomplished by at least one of:
accumulating virtual money that is usable in the virtual reality world;
acquiring products through making purchases in the virtual reality world;
developing a talent in the virtual reality world; and
enhancing a personal image in the virtual reality world.

13. The system of claim 11, wherein a reward can be earned by the virtual consumer due to attainment of a specified level of virtual social status.

14. The system of claim 13, wherein the reward is at least one of:
allowing the virtual consumer to visit a status location within the virtual reality world;
providing a status email address for the user;
providing a status membership card to the user; and
awarding a prize to the user.

15. The system of claim 1, wherein the user is able to control the virtual consumer so as to earn virtual money for use in purchasing consumables in the virtual reality world.

16. The system of claim 1, wherein the user is able to earn virtual money for use in purchasing consumables in the virtual reality world by using real money to purchase a consumable in the virtual reality world.

17. The system of claim 1, wherein the user is able to earn virtual money for use in purchasing consumables in the virtual reality world by purchasing a real consumable from a real place of business that corresponds to a simulated place of business in the virtual reality world.

18. The system of claim 1, wherein the virtual reality world includes at least one virtual city that corresponds to a real-world city.

19. The system of claim 1, wherein the virtual consumer is able to interact socially within the simulated interior space of the simulated place of business, the social interaction being with other virtual consumers controlled by other users.

20. The system of claim 1, wherein the user is able to adjust a virtual physical characteristic of the virtual consumer so as to approximate a corresponding physical characteristic of the user.
